(19) United States
(12) Patent Application Publication
(10) Pub. No.: US 2011/0018264 A1
(43) Pub. Date: Jan. 27, 2011

(54) ENERGY CONVERSION AND ACCUMULATION DEVICE AND RELATIVE METHOD

(75) Inventors: Aldo Romani, Rimini (IT); Cinzia Tamburini, Rimini (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: EUROTECH SPA, Amaro (IT)

(21) Appl. No.: 12/867,158

(22) PCT Filed: Feb. 4, 2009
(86) PCT No.: PCT/EP09/51275

§ 371 Date: Aug. 11, 2010

(30) Foreign Application Priority Data
Feb. 12, 2008 (IT) UD2008A000028

(51) Int. Cl. F03G 7/08

(52) U.S. Cl. 290/7

(57) ABSTRACT

An energy conversion and accumulation device, for the conversion of environmental energy into electric energy, includes a transducer, able to convert external environmental stress into an electric quantity, a storage element to accumulate and/or transfer the electric quantity to an electric device, a first switch element, activated in order to transfer electric energy from the transducer directly to a temporary storage element, and a second switch element activated in order to transfer electric energy stored by the temporary storage element directly to the storage element. The device further includes a sensor element, associated with the transducer, temporary storage element, and storage element. The sensor element detects predetermined energy conditions favorable for the selective and/or mutually alternate activation of the switch elements for a corresponding alternate electric energy transfer respectively from the transducer to the temporary storage element and from the temporary storage element to the storage element.

### CROSS-REFERENCE TO RELATED APPLICATIONS

This application is a Section 371 of International Application No. PCT/EP2009/041275, filed Feb. 4, 2009, which was published in the English language on Aug. 20, 2009, under International Publication No. WO 2009/101013 A2 and the disclosure of which is incorporated herein by reference.

### BACKGROUND OF THE INVENTION

Embodiments of the present invention are directed to an energy conversion and accumulation device usable for the extraction of energy from the environment outside the device, and the relative conversion and accumulation method.

In particular, embodiments of the present invention are applied to electronic circuits for the extraction of environmental energy, as for example mechanical, thermal or light energy, in order to accumulate the energy in electric form and/or to transfer the energy so as to feed an associated electric user device.

Devices to extract and accumulate environmental energy are known, able to extract and convert this energy into electric energy and subsequently to transfer the electric energy to an accumulation and/or user device.

A first group of known devices, of the passive type, usually include a transducer suitable to extract and convert environmental energy into alternate electric energy. These devices also include rectification elements to rectify the electric quantities, typically formed by networks of diodes which, following the aforesaid extraction, convert the alternate electric energy into continuous electric energy and transfer it to an accumulation and/or user device.

One disadvantage of these devices is that the rectification elements, in particular the diodes, tend to dissipate part of the converted electric energy, due to their internal resistance, substantially variable with the work point of the diode. This dissipation reduces the efficiency and performance of the device. Moreover, part of the electric tension converted is lost in the direct polarization tension of the diode.

Furthermore, the devices operate efficiently in a predetermined work point, substantially depending both on the electric input signal and also on the current absorbed by the load. If the electric input signal consists of a piezoelectric transducer for the extraction of vibratory mechanical energy, each random vibration causes a continuous displacement of the work point of the diodes from the ideal work condition. This is translated into continuous deviations of the real performance from the maximum performance for which the device was designed.

Another disadvantage is that, in the event of random or similar vibrations, it is not possible to extract energy from the transducer if the output tension of the transducer is less than the tension downstream of the rectification elements.

A second group of known devices, of the active type, include a control unit suitable to detect the electric energy converted by the transducer and subsequently to control, by way of analogical switches, such as for example MOSFET transistors, an energy amplification/extraction unit, based on the detection, in order to feed a storage element for electric energy. Moreover, the amplification/extraction unit includes resonant electric circuits coupled with the transducer, which allow an increase in the efficiency of the energy extraction.

One disadvantage of this second type of device is that the switching frequency of the analogical switches is pre-established in a range of frequencies that might not be suitable for switching frequencies of a random nature, like those that are generated on the energy transducer.

It is therefore desirable to provide an energy conversion and accumulation device that increases the quantity of energy accumulated and/or transferred, irrespective of the current absorbed by the electric user device or of the functioning condition of the device itself.

It is further desirable to provide an energy conversion and accumulation device that operates with constant efficiency, even when the input energy has irregular aperiodic characteristics.

It is further desirable to provide an energy conversion and accumulation method that allows optimization of the efficiency of conversion independently of the load fed by the device and of its electric condition.

Embodiments of the present invention are directed to overcoming such shortcomings and to obtain the above described advantages.

### BRIEF SUMMARY OF THE INVENTION

An energy conversion and accumulation device according to the present invention is applicable for the conversion of environmental energy, for example mechanical, thermal, light or the like, into electric energy, in order to accumulate and/or transfer it to an electric user device.

The energy conversion and accumulation device according to the present invention includes at least a transducer, for example of the piezoelectric type, suitable to convert an environmental stress outside the device and applied to one entrance thereto, into an electric quantity. The conversion device also includes at least an energy storage element, suitable to receive in one entrance the electric quantity of the transducer, and to accumulate the electric quantity or use the electric quantity to feed an electric user device connected to an outlet thereof.

The energy conversion and accumulation device also includes a first switch element able to be activated to transfer electric energy from the transducer to a temporary electric energy storage element, interposed between the transducer and the electric energy storage element. The device also includes a second switch element able to be activated to transfer energy stored by the temporary storage element to the storage element.

In one aspect, the energy conversion and accumulation device includes a sensor element, associated both with the transducer and with the temporary storage element and also with the storage element. The sensor element is suitable to detect predetermined energy conditions favorable for the selective and/or mutually alternate activation, or closure as will be described in more detail hereafter, of the first switch element and the second switch element respectively to transfer energy from the transducer to the temporary storage element and from the temporary storage element to the storage element. In this way the energy conversion and accumulation device is temporally separated, by way of the two switch elements, first and second, into two distinct subdevices, of which a first subdevice includes the transducer and the temporary storage element and a second subdevice includes the temporary storage element and the storage element. In this way, the transfer of electric energy from the transducer to the storage element is never influenced by the functioning condition of the storage element, since the latter two are in fact electrically disconnected, and/or by the working conditions of the electric user device.

The energy conditions detected by the sensor element may include, for example, whether a predetermined tension threshold has been reached at the outlet from the transducer element or a maximum inlet current in the temporary storage element. In this way it is possible to transfer to the temporary storage element minimal, random and/or aperiodic variations in energy produced by corresponding variations in the environmental stresses, thus increasing the quantity of environmental energy convertible and hence the energy efficiency of the energy conversion and accumulation device.

In another aspect, the energy conversion and accumulation device includes a control unit, associated with the sensor element, and suitable to activate switch elements according to the data detected of said energy conditions.

In another aspect, the control unit is associated with a processing unit suitable to calculate the opening and closing times of the switch elements and the corresponding instants the switch elements are activated, according to the data detected of said energy conditions detected by the sensor element.

In this way it is possible to store the energy associated with the variable electric quantity exiting from the transducer and to transfer the energy to the storage element and/or to the electric user device only in effectively favorable energy conditions, as detected by the sensor element and/or calculated according to the electric characteristics of the accumulation device and/or the electric user device and the electric quantities detected during its functioning.

In another aspect, the transducer includes an exit door that can be configured as an electric charge capacity, obtained from the environmental energy.

Embodiments of the present invention are also directed to an energy conversion and accumulation method, to convert environmental energy into electric energy, and to accumulate it in an energy storage element and/or to transfer it to an electric user device, fed by the energy storage element.

The method includes a first step in which, by way of at least one transducer, environmental energy associated with an entrance to the transducer is converted into an electric quantity associated with an exit of the transducer. The at least one transducer is selectively connectable by way of a first switch element, open in the first step, to a temporary electric energy storage element, in turn selectively connectable to at least an electric energy storage element, by way of a second switch element, also open in the first step.

The method also includes a second step in which the electric quantity is transferred to the temporary energy storage element.

In one aspect, the second step includes a sub-step in which the first switch element is closed, thus creating the connection that allows the transfer, in correspondence with predetermined energy conditions of the transducer, favorable for the transfer of energy and detected by way of a sensor element at the end of the first step. The second switch element is kept open during this sub-step. In this way the first switch element allows to convert energy and accumulate the energy temporally when the energy state of the transducer is favorable to the transfer of electric energy to the temporary storage element, such as for example when a predetermined tension output threshold of the at least one transducer has been reached.

In another aspect, the second step includes a subsequent sub-step in which the first switch element is opened according to the energy conditions of the transducer and/or of the temporary storage element, as detected by the sensor element at the start of the second step.

The method includes a third step in which the first switch element remains open and subsequently the second switch element is closed, so as to allow the permanent storage of the electric energy transferred from the transducer and/or so as to feed the electric user device.

In another aspect, in the third step the second switch element is subsequently opened according to the energy conditions of the storage element and/or of the temporary storage element, as detected by the sensor element.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is functional block diagram of the energy conversion and accumulation device according to the present invention;

FIG. 2 is an electric circuit diagram that achieves the device of FIG. 1;

FIG. 3 shows the diagram of FIG. 2 in a first working configuration;

FIG. 4 shows the diagram of FIG. 2 in a second working configuration;

FIG. 5 shows the diagram of FIG. 2 in a third working configuration;

FIG. 6 shows the diagram of FIG. 2 in a fourth working configuration;

FIG. 7 is a diagram illustrating the development in time of some electric quantities of the diagram in FIG. 2 in the configurations shown of FIGS. 3 to 6;

FIG. 8 shows the diagram of FIG. 2 in a fifth working configuration;

FIG. 9 shows the diagram of FIG. 2 in a sixth working configuration;

FIG. 10 is a block diagram that shows the transfer of energy in the device of FIG. 1;

FIG. 11 is a second electric circuit diagram that achieves the device of FIG. 1;

FIG. 12 shows a variant of the electric circuit diagram of FIG. 2;

FIG. 13 shows a variant of the electric circuit diagram of FIG. 11;

FIG. 14 is a temporal diagram of the tensions in the circuit of FIG. 12;

FIG. 15 is a temporal diagram of the tensions in the circuit of FIG. 13;

FIG. 16 shows a variant of the electric circuit diagram of FIG. 13;

FIG. 17 shows a variant of the electric circuit diagram of FIG. 12;

FIG. 18 shows a temporal diagram of a generic oscillating circuit LRC.

### DETAILED DESCRIPTION OF THE INVENTION

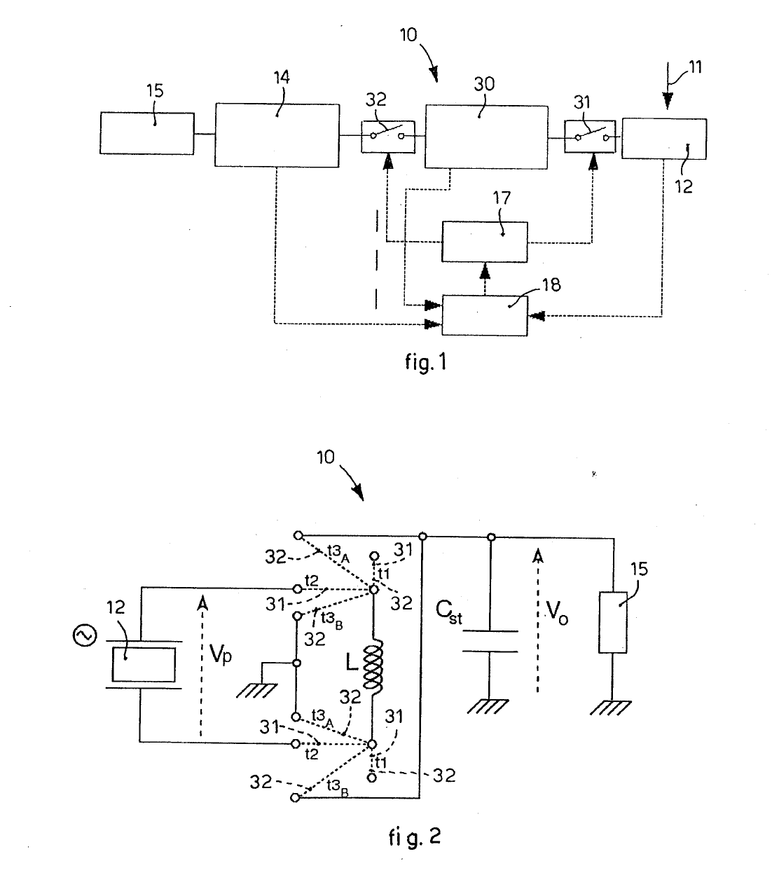

With reference to FIG. 1, an energy conversion and accumulation device 10 according to the present invention includes an energy transducer 12, an energy storage element 14, a control unit 17, a sensor 18 and a first switch element 31.

The transducer 12 is suitable to convert an environmental physical quantity 11 of the variable type into a variable electric quantity. The transducer 12, of a known type, for example a piezoelectric transducer, is able in this case to convert incident mechanical energy 11, for example of a vibratory type, into a variable electric quantity, for example a tension Vp. The transducer 12 can be of any type, however, substantially chosen according to the type of environmental quantity to be converted.

The device 10 also includes an energy storage element 14, suitable to accumulate the electric energy converted by the transducer 12 and/or to transfer it to an electric charge 15.

The storage element 14 is of a known type and can for example include, in a preferred embodiment, a high capacity condenser, or for example a battery with the corresponding recharging circuit, both not shown in the attached drawings. FIG. 2 shows an electric circuit diagram that includes the device 10 of the block diagram in FIG. 1. The energy storage element 14 includes a condenser C_{ST} connected in parallel to the electric charge 15 to be fed, in this case represented by an equivalent resistance element.

The control unit 17, for example of the low consumption microprocessor type so as to minimize its consumption of energy taken from the storage element 14, is suitable to activate the first switch element 31 in order to transfer the variable electric quantity exiting from the transducer 12. The control unit 17 is also connected to the sensor 18, suitable to provide an indication of the energy state inside the transducer 12 so as to allow the control unit 17 to open/close the first switch element 31 when considered energetically appropriate, as will be described in more detail hereafter. In this case the electric quantity is the tension exiting at the heads of the transducer 12 and is detected for example by an Analog-Digital conversion device (ADC). Here and in the rest of this description the term “activation” or “closure” of a switch shall be taken to mean the disposition of the switch so as to create an electric connection between two devices disposed at opposite heads of the switch, whereas the term “opening” or “de-activation” of the switch shall be taken to mean the disposition of the switch so as to separate said devices electrically.

According to a variant, the control unit 17 can be made with a personalized circuit logic, with high integration and very low consumption, for example with CMOS elements, so as to optimize the consumption of electric energy adapting them to the specific circuit embodiment.

The device 10 also includes a temporary energy storage element 30, connected by the first switch element 31 to the transducer 12 and by way of a second switch element 32, again commanded by the control unit 17, to the energy storage element 14. Again with reference to FIG. 2, in which neither the sensor 18 nor the control unit 17 have been indicated, the temporary energy storage element 30 includes an inductor L, the value of which is chosen according to the characteristics of the transducer 12, the energy absorbed and the characteristics of the storage element 14, that is, the value of the condenser C_{ST}. The value of inductance of the inductor L also determines the duration of the tension transients following the switching of the switches, so as to render the transients in oscillating form. In this way, during the energy transfer, the electric energy dissipated in the in-series resistances of the circuit elements is minimized.

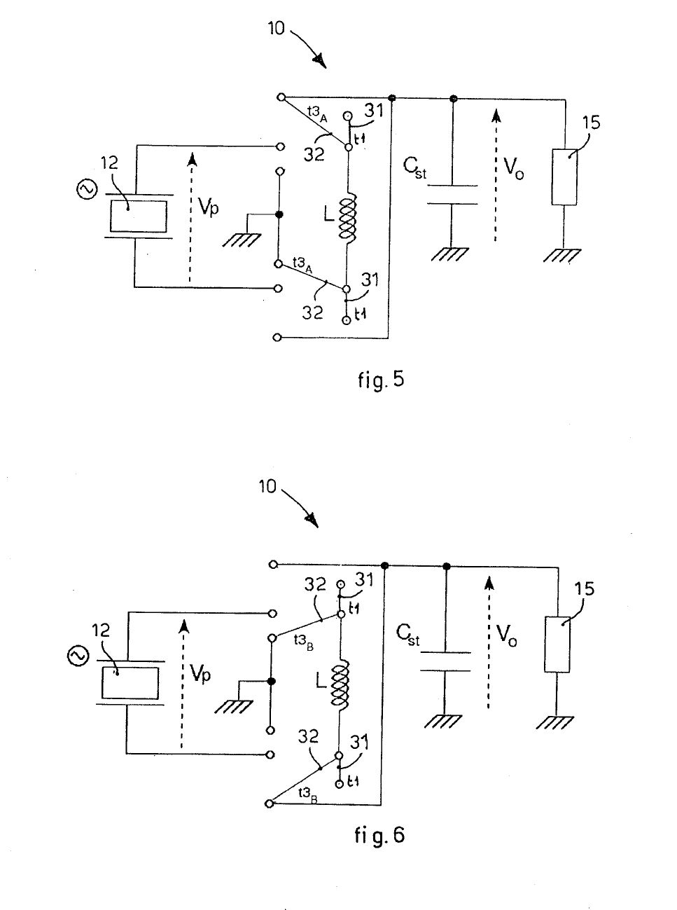

The switch elements 31, 32 connecting to the transducer 12 and to the storage element 14 include switches of the multi-position type or a set of individual switches, the state of which is suitably controlled by the control unit 17. In this case, with reference to FIGS. 2-6, the first switch element 31 is made by a configuration of two multi-position switches in the configurations indicated by t1 and t2, and the second switch element 32 is also made by the same multi-position switches in the configurations indicated by t3_{A} and t3_{B}.

In this way, the multi-position switch elements 31, 32 form a network of switches, each of which is provided with two gates, an inlet gate with two terminals, connectable in the case of the first switch element 31 to the transducer 12, and an outlet gate with two terminals, again connectable in the case of the first switch element 31 to the temporary storage element 30. The multi-position switch elements 31, 32, suitably activated by means of the control unit 17, as will be described in more detail hereafter, allow to transfer, directly and efficiently, the electric energy converted by the transducer 12, obviating the need to interpose rectification devices or straighteners, such as networks of diodes and/or passive components. This therefore allows to connect respectively directly and at predetermined instants the transducer 12 to the temporary storage element 30 and, subsequently, the temporary storage element 30 to the storage element 14 and hence to the electric charge 15.

Furthermore, as will be described hereafter, the multi-position switch elements 31, 32 allow to render dynamic the connection of the connection terminals of the transducer 12 and of the temporary storage element 30, in this case of the inductor L, respectively to the terminals of the transducer 12 and to those of the storage element 14. In this way it is possible to avoid a permanent connection between one of the connection terminals of the transducer 12 or the temporary storage element 30 with one or more reference points of the electric circuit. This allows to render more efficient the energy transfer from the transducer 12, substantially reducing any transitory phenomena or losses of energy due to dissipation on parasite resistances.

The energy storage element 14 includes a condenser C_{ST} of the supercap type, or a low losses condenser for example made of polypropylene, or a battery and corresponding recharging circuit.

The device 10 as described heretofore functions as follows.

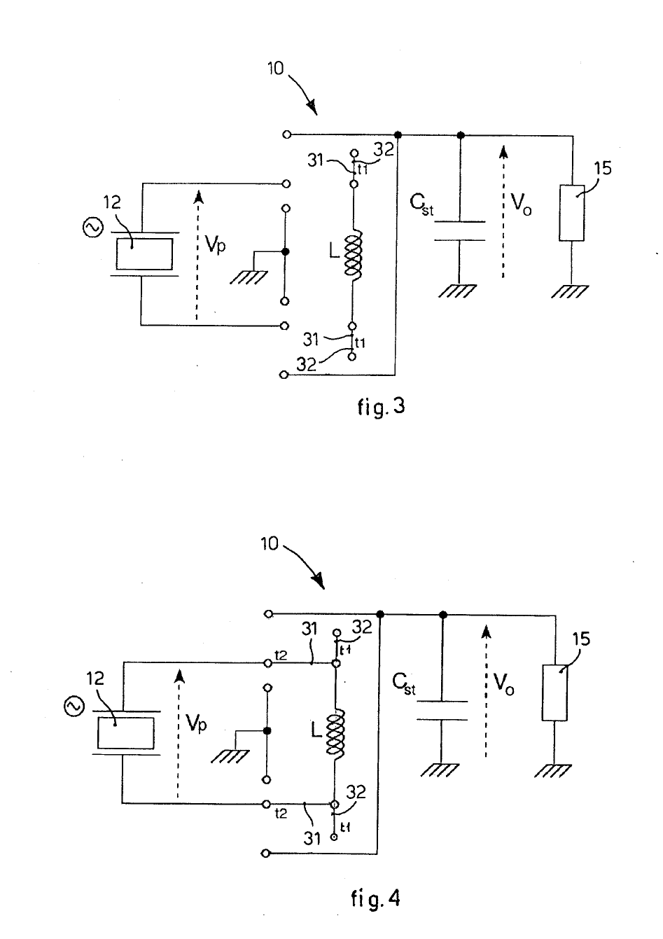

With reference to FIGS. 3-6, which show different working configurations, Vo(t) indicates the tension on the storage condenser C_{ST}, with Z(t) the tension at outlet from the transducer 12 which there would be under idle functioning, that is, in the absence of an energy transfer. Vp(t) indicates the tension at exit from the transducer 12, which is obtained by activating the energy transfer. FIG. 7 shows the temporal development of said tensions in the different working configurations shown in FIGS. 3-6.

In a first step, shown in FIG. 3, the configuration of the first multi-position switch 31 indicated by t1, commanded by the control unit 17 and not shown in the drawings, is such that the piezoelectric transducer 12 is left in an open circuit condition, and remains substantially disconnected from the temporary storage element 30.

In a second step the energy accumulated at exit from the transducer 12 is transferred to the temporary storage element 30 by way of selective and mutually alternative switching of the multi-position switches 31, 32. The first switch element 31 is closed, allowing the electric connection of the transducer 12 to the temporary storage element 30, keeping the second switch element 32 open and therefore electrically disconnecting the temporary storage element 30 from the storage element 14, and hence from the load. The second step includes a first sub-step in which, when at exit from the transducer 12 a predetermined energy condition is reached, as detected by the sensor 18, and considered favorable to the energy transfer, the control unit 17 switches the multi-position switches 31, 32 to a configuration indicated by t2, so as to connect the inductor L to the transducer 12. The favorable energy condition for example consists of a local maximum or local minimum value of the tension Vp.

The second step includes a second sub-step in which the configuration t2 of the multi-position switch elements 31, 32 is modified so as to disconnect the inductor L from the transducer 12. Advantageously the configuration t2 is maintained for a quarter period of the oscillation frequency, that is, until the tension Vp at exit from the transducer 12 is annulled, or the current iL circulating on the inductor L is at its maximum.

In this configuration of the multi-position switch elements 31, 32, all the electrostatic energy stored at exit from the transducer 12 is transferred to the inductor L in the form of magnetic energy. The transfer of energy occurs with a transitory development of a damped oscillatory type, depending on the characteristics both of the transducer 12 and also of the inductor L.

Indicating the equivalent capacity of the transducer 12 by Cp, and ignoring the effect of the resistances of the switches and of the inductor, the development of the tension at exit from the transducer 12, and therefore at the heads of the inductor L, and of the current in the circuit during said second step is given by the following formulas:

$$i ( t ) = {V}_{P} \sqrt{\frac{{C}_{P}}{L}} sin ( \frac{1}{\sqrt{{LC}_{P}}} )$$

$$v ( t ) = {V}_{P} cos ( \frac{1}{\sqrt{{LC}_{P}}} t )$$

The tension and current wave forms are therefore sinusoidal and are interrupted, as we said before, when the tension on the inductor L is annulled or the current flowing in the inductor L reaches its maximum.

The energy transferred by the transducer 12 to the inductor L is quantifiable with the following formula:

$$Δ E = \frac{1}{2} {C}_{P} {V}_{P}^{2} = \frac{1}{2} {LI}_{L max}^{2}$$

In a third step, shown in FIG. 5, according to the direction the current flows in the inductor L as detected by the sensor 18, the control unit 17 switches the multi-position switch element 32 to a third configuration, indicated either by t3A, if the tension Vp is positive, or t3B if the tension Vp is negative. In this configuration the inductor L is connected to the storage condenser C_{ST} and disconnected from the transducer 12. In this step another energy transfer is triggered which again occurs according to an oscillatory transient. This working configuration is maintained for a maximum duration of a quarter of the oscillation period before allowing the oscillation of the electric quantities to continue. The control unit 17 again switches the multi-position switch into the position corresponding to the first configuration shown in FIG. 3.

Therefore, the conversion and transfer device 10 is temporally separated by way of the switch elements 31, 32 into two distinct subcircuits, in which the first subcircuit includes the transducer 12 and the temporary storage element 30, and a second subcircuit includes the temporary storage element 30 and the storage element 14. Therefore, the overall transfer of electric energy from the transducer 12 to the storage element 14 is never influenced by the functioning state of the storage element 14, since the latter is in fact electrically disconnected, and/or by the working conditions of the electric charge 15.

Furthermore, as shown in FIG. 10, the only return energy is that which the transducer 12 returns to the environment, if any. Therefore the stream of converted energy always flows in a direction that goes from the transducer 12 to the storage element 14. This entails a greater yield and a greater conversion efficiency.

In the third step it is possible to indicate for the exit condenser C_{ST}:

$$Δ {V}_{o} = \sqrt{{V}_{st}^{2} + \frac{L}{{C}_{st}} i {L}^{2}} - {V}_{st}$$

where Vst and iL are the initial values, for the current transfer cycle, of the tension at the heads of the condenser C_{ST} and the current in the inductor L.

Therefore, with every activation, if for example the mechanical vibrations have a constant maximum amplitude, a constant quantity of energy is transferred, if we hypothesize that the in-series resistances of the circuit elements are zero. In this hypothesis, if we indicate by n the number of conversion cycles effected, we can write the following equations:

$${V}_{0} ( n ) = {V}_{P} ( n ) \sqrt{\frac{{C}_{p}}{{C}_{st}}}$$

$$\sqrt{n} = {V}_{0} ( n - 1 ) \frac{\sqrt{n}}{\sqrt{n - 1}}$$

$$Δ E ( n ) = \frac{1}{2} {C}_{p} {V}_{P}^{2}$$

Therefore, in the configurations where no energy is transferred from the transducer 12 to the inductor L, the condenser C_{ST}, and therefore the electric charge 15 also, are disconnected from the transducer 12 and from the inductor L, allowing to design the device 10 efficiently. Therefore the relative components can be designed without taking into account possible inter-dependencies.

Moreover, again in the simplified hypotheses as above, the yield of the device 10 is constant, since the same quantity of converted and transferred energy can be made to correspond to each energy transfer.

In addition, the device 10 also works excellently in situations where the vibrations are irregular. In fact the device operates when there is effectively present a tension Vp generated by the transducer 12 and detected by the sensor 18, for example using as a rule for evaluation the accumulation of a sufficient quantity of energy, based on a maximum detected, in an absolute value, of the tension Vp. Therefore, by way of a single control unit 17, together with the sensor 18, it is possible to detect the optimum conditions of energy transfer, such as for example maximum or minimum conditions of the outlet tension of the transducer 12 or predetermined threshold values, by activating the multi-position switches 31, 32 at the desired instants and for the time necessary to transfer the energy.

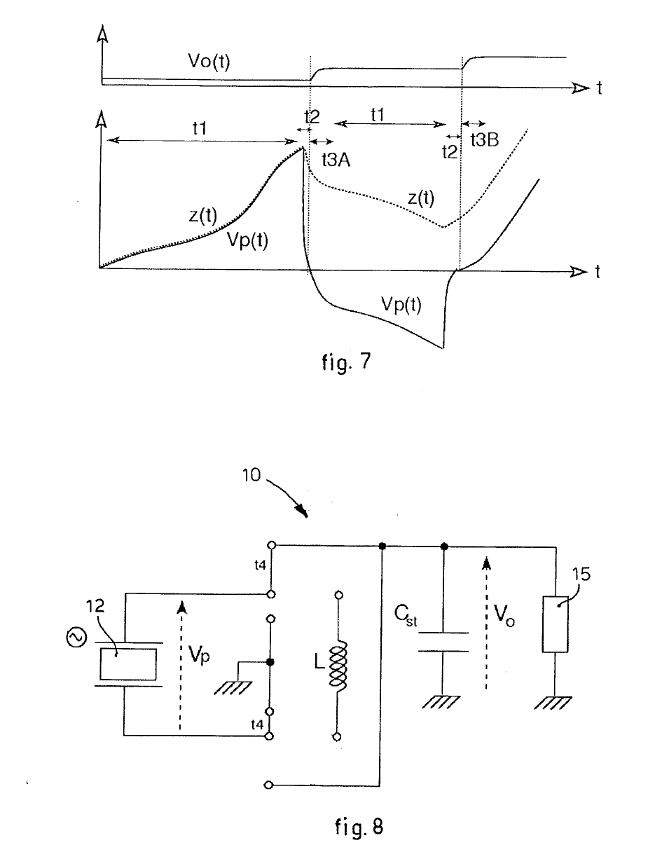

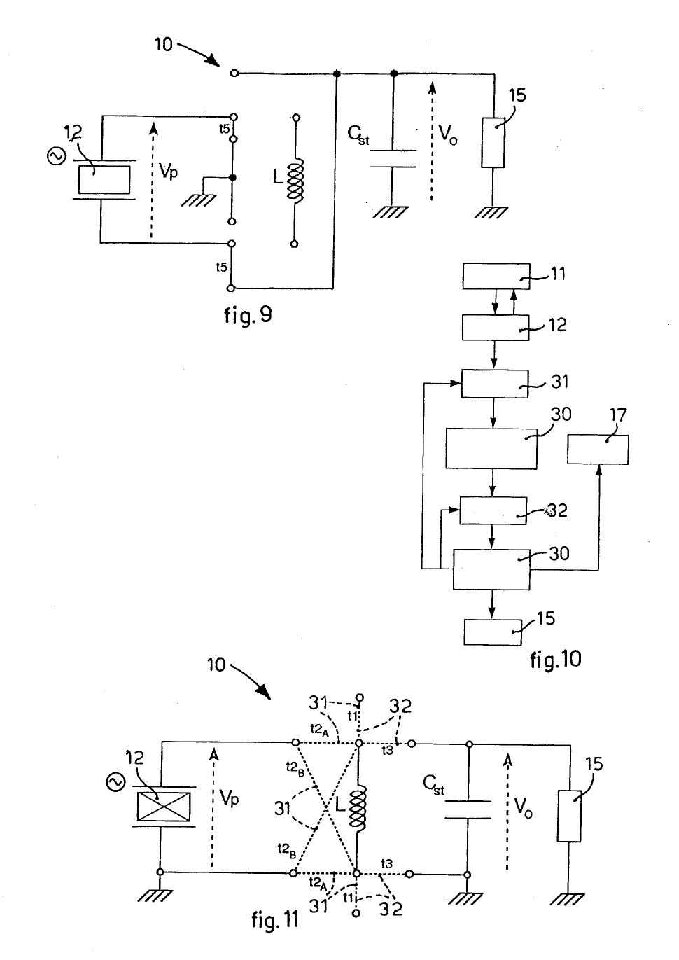

According to a variant shown in FIGS. 8 and 9, it is possible to effect a direct transfer of electric charge and therefore of accumulated energy directly from the transducer 12 to the condenser C_{ST}. The working configurations of the multi-position switches 31, 32 that allow the direct transfer are indicated respectively by t4 and t5 and are activated dynamically by the control unit 17 in those situations where the transfer of charge to the condenser C_{ST} is most efficient. This variant substantially emulates the conversion and rectification of electric quantities like a diode bridge, but with greater efficiency.

FIG. 10 shows the stream of energy, comprising transfer, accumulation and feed, of the conversion and accumulation device according to embodiments of the present invention.

FIG. 11 shows a different form of embodiment of the circuit where the first switch 31 is achieved by the positions t1, t2A and t2B of the multi-position switches activated according to the sign of the tension Vp at the heads of the transducer 12, the second switch 32 is achieved by the position t3 of the multi-position switches.

According to a variant shown in FIG. 12, deriving from the circuit in FIG. 2, and in which the electric charge 15 is not shown, it is possible to provide the extraction of electric energy from a plurality of piezoelectric transducers 12, operating independently of each other with autonomous mechanical and tension responses and disposed according to a parallel circuit diagram, by using other independent switches SW1, SW2 . . . SWn which connect the exit of each transducer to a common reference circuit point Vpx. Each switch SW, can be activated in a mutually exclusive manner with respect to the others so as to connect a single transducer 12 at a time to the inductor L. In the first step of the conversion, if a maximum or minimum tension V_{Pi} is detected relating to the transducer with capacity Cpᵢ, the control signal relating to the switch SW, is activated together with switch SW₀, that is, the switches SWᵢ and SW₀ are closed, keeping open the switches SWB1, SWB2 and SWA. The second step has two modes: if previously a maximum had been detected, the switches SWᵢ and SW₀ are opened and subsequently the switches SWB1, SWB2 are closed, keeping open the switches SWA and SW₀. On the contrary, if a minimum tension had been detected, the switches SWA and SW₀ are closed, with the switches SWB1, SWB2 kept open.

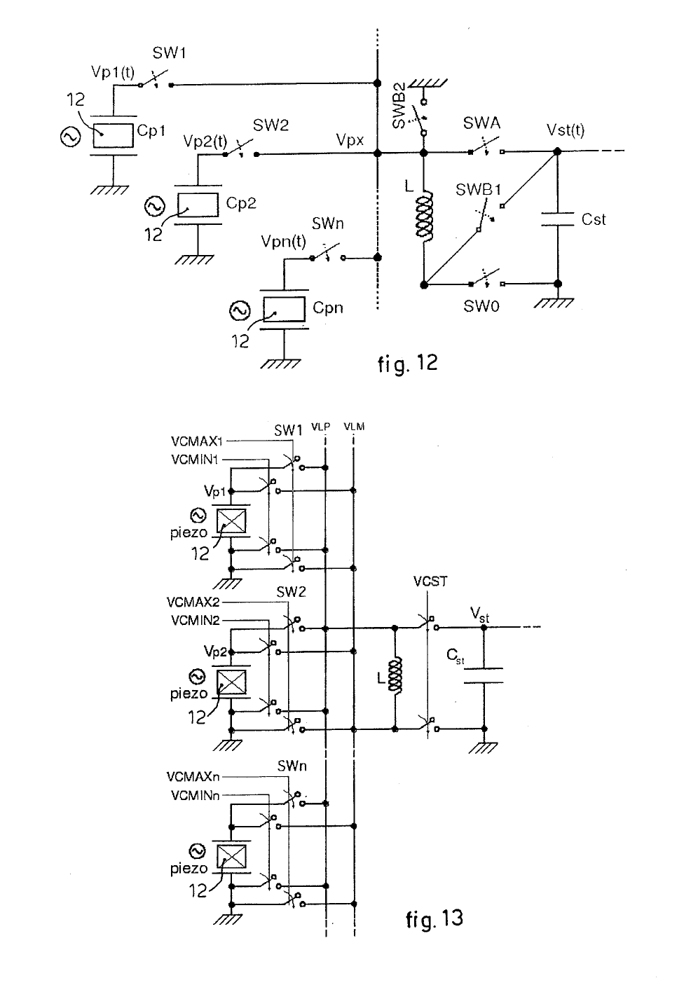

According to another variant, shown in FIG. 13, the extraction of electric energy always takes place by way of a plurality of piezoelectric transducers 12 disposed according to a diagram deriving from the circuit in FIG. 11. If a maximum (or minimum) tension V_{Pi} is detected relating to the transducer with capacity Cpᵢ, in the first stage of the conversion the corresponding control signal VCMAXᵢ (or VCMINᵢ) is activated so as to close the corresponding two-way switch SWᵢ. In the second step, on the contrary, the VCST signal is activated which determines the closure of the two-way switch, connecting in parallel the inductor L on the condenser C_{ST}. Each switch SW, can be activated in a mutually exclusive manner with respect to the others, as previously described.

In both the case of the circuit shown in FIG. 12, and also the circuit in FIG. 13, the frequency of the vibrations of the transducer 12 is low enough to allow a multiplexing in the time of the transducers 12 disposed in parallel. In fact, for most of the time the transducers 12, as described before, are disconnected and therefore decoupled from the rest of the circuit. Therefore the control unit 17 detects by way of the sensor 18, not shown in the drawings, the tensions of all the “n” transducers 12, and if a maximum energy is detected on one of them, the relative switches are activated as described before.

The time required by the control unit 17 to read the state of all the piezoelectric transducers 12 is n*t_{READ}, with t_{READ} being the time for reading a single transducer 12. Reading the n transducers it is possible that a certain number of them (for example M) are in a configuration corresponding to a maximum energy detected at the same time; in this case the relative conversion is activated for each of them, in sequence, and has a variable duration. Therefore in a first step, with a constant duration for every individual transducer 12, which has been read at a maximum electrostatic energy, it is discharged at 0 volts whereas at the same time the electric current in the inductor L increases to its maximum value. Subsequently, the inductor L loads the condenser C_{ST} during a step having a variable duration, that is, until the current delivered by the inductor L is annulled.

The duration of the control cycle carried out by the control unit 17 is obtained by the following formula:

$$Δ {T}_{CONTROL} = N \cdot Δ {t}_{READ} + {\sum }_{i = 1}^{M} Δ {t}_{XFER} ( i )$$

So that the circuit functions adequately, the following equation must be valid: 1/ΔT_{CONTROL}<<f_{VIBES} (f_{VIBES} being the frequency of the maximum spectral component included in the vibrations). In this way, even if several maximums of electrostatic energy are detected simultaneously, it is possible to manage them sequentially, preventing the transducers 12 from moving significantly away from their maximum energy condition.

It is also better if ΔT_{SAMPLE}>>ΔT_{CONTROL}, that is, the sampling range ΔT_{SAMPLE} is much greater than the duration of the control cycle ΔT_{CONTROL}, so that the management of the energy conversion occupies a small fraction of the sampling time. This limitation is not restrictive, since an irregular variation or jitter may be tolerated on the sampling instants, given the irregularity of the sources, that is, the transducers 12.

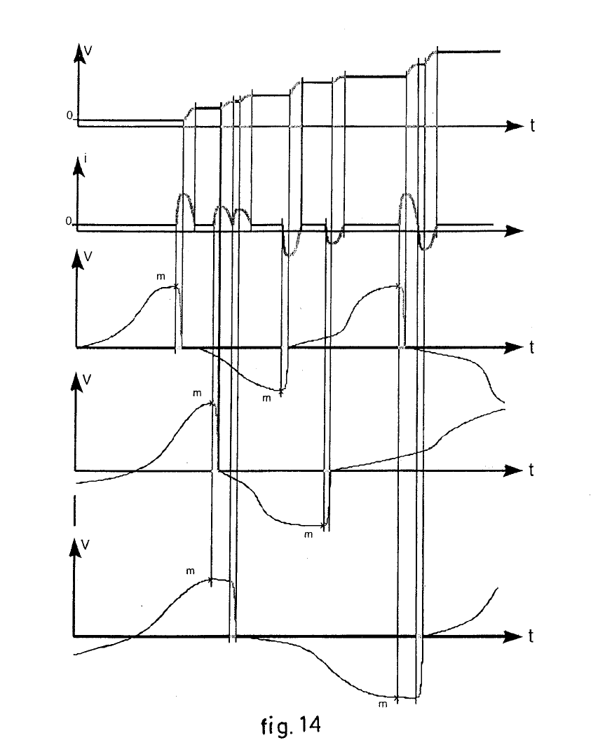

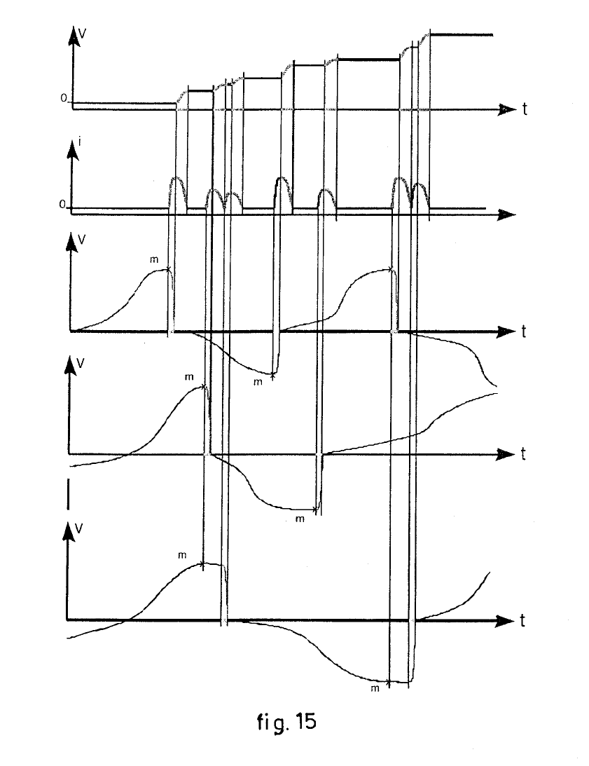

FIGS. 14 and 15 show the wave forms relating to the functioning respectively of the circuits in FIGS. 12 and 13.

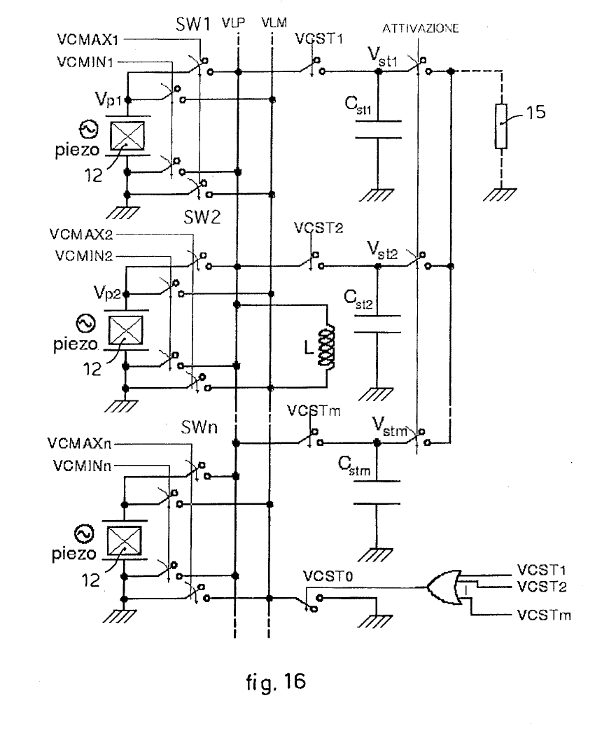

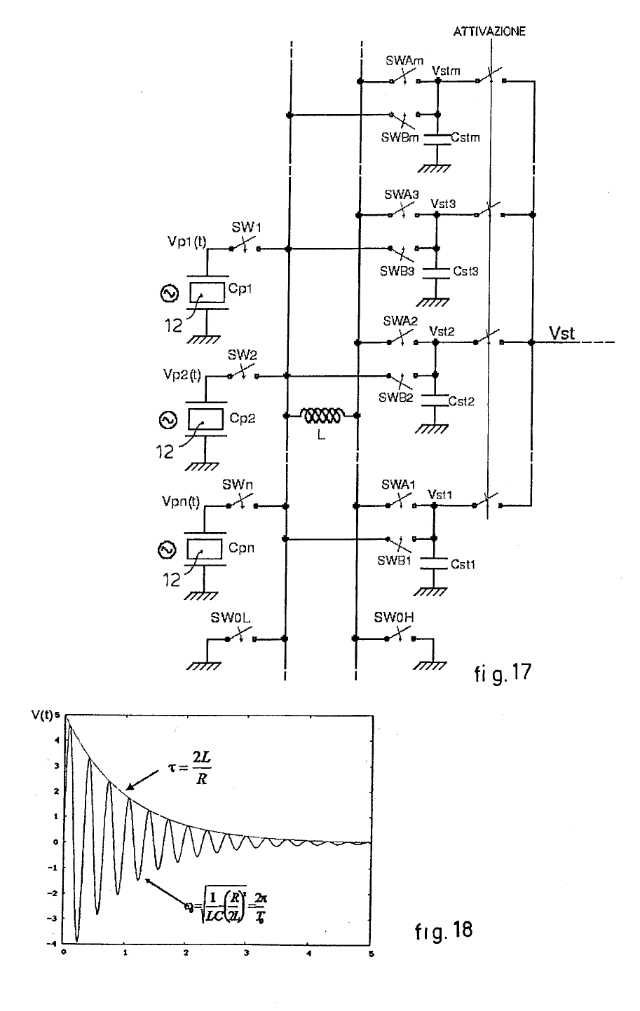

According to another variant shown in FIGS. 16 and 17, it is possible to achieve a storage element 14 by way of a plurality of condensers Cst1, Cst2, . . . Cstm, each one having a lower capacity than the capacity of the single condenser described in the previous circuit diagrams and disposed so as to be activated in parallel. In this way it is possible to further increase the performance of the energy transfer from the transducers 12 to the electric charge 15.

In fact, in the circuit diagrams described above, there are parasite resistances present, in this case that of the inductor L and of the multi-position switches 31, 32. These parasite resistances will be indicated by the reference terms R_{PAR1} and R_{PAR2}.

During the energy transfer between the transducer 12 and the inductor L, the increase in current i_{L} in the inductor L and the discharge of the transducer 12 consequent to the detection of a maximum/minimum tension can be modeled with a transitory development of a damped oscillating circuit L C_{P} R_{PAR1}. In particular, the duration of each phase is always equal in the first approximation to a quarter of the period of natural oscillation.

Furthermore, during the energy transfer from the inductor L to the condenser C_{ST}, the increase in tension V_{ST} on the condenser following the switching of the multi-position switches 31, 32 can be modeled as a transient of an oscillating circuit LC_{ST}R_{PAR2}, with initial conditions V_{ST}(0)=V_{ST0}, i_{L}(0)=i_{L}0, the duration of which is always less than one quarter of the period of natural oscillation.

FIG. 18 shows the temporal development of a free oscillation of a generic circuit LCR. With regard to the phases of energy transfer of the device according to the present invention, it is possible to observe that if the constant of dampening time t is reduced, relating to the period of oscillation T₀=2π/ω₀, with every period of oscillation (or fraction thereof) there will be a lower tension: this means that the energy dissipated in losses on the parasite resistances increases with every oscillation. Therefore it is important to render the value of τ as big as possible with respect to the period of free oscillation T₀, so that the amplitude of oscillation can be reduced as slowly as possible. In this way it is possible to determine the performance of the convertor directly.

This can be done by increasing the value of inductance of the inductor L, but this may consequently increase the associated in-series resistance, because it consequently increases the numbers of coils, or by reducing the value of capacity of the condenser C_{ST}. However, this capacity cannot be as small as desired, since it may be required to accumulate a quantity of load Q on the condenser C_{ST} such as to directly feed an electric charge 15 functioning at a predetermined feed tension V_{DD} according to at least the following operating conditions. The tension developed, with a value Q/C_{ST}, must be almost equal to the maximum feed tension V_{DD,MAX} tolerable by the user load. Furthermore, it is necessary to guarantee at least a minimum time when the user load is switched on, during which the tension on the condenser must not go below the minimum feed tension required by the user circuit V_{DD,MIN}.

For example, if an electric charge 15 can function for feed tensions included between 5.5V and 4.5V, the condenser C_{ST} must have a capacity big enough so that, in the time range Δt when the load is activated, the tension on the condenser C_{ST} does not go below 4.5V. The higher the current required by the electric charge 15 while it is switched on, the greater is the value required of the capacity of the condenser C_{ST}.

Therefore, as shown in FIGS. 16 and 17, a number “m” of condensers Cₛₜ₁, Cₛₜ₂, . . . Cₛₜₘ is used, having capacity equal to C_{ST}/N, each of which is loaded individually, that is, one at a time, activating in a mutually exclusive manner a corresponding outlet switch, at the desired tension. Once all the condensers Cₛₜᵢ have reached the desired tension level, they are connected in parallel toward the user load. The condensers Cₛₜᵢ have a capacity such as to achieve a parallel equivalent capacity of a predefined value such as to provide the electric charge 15 with a level of feed tension for at least a predetermined functioning interval usable to carry out specific tasks or functions.

In fact in this way all the individual energy conversions benefit from a greater efficiency because:

$$\frac{τ ( {R}_{PAR 2} , \frac{{C}_{ST}}{N} , L )}{{T}_{0} ( {R}_{PAR 2} , \frac{{C}_{ST}}{N} , L )} > \frac{τ ( {R}_{PAR 2} , {C}_{ST} , L )}{{T}_{0} ( {R}_{PAR 2} , {C}_{ST} , L )}$$

where τ is the time constant relating to damping and T₀ is the period of natural oscillation.

Furthermore, considering the parasite effects of a real condenser, which can be represented as an ideal capacity in series with an equivalent in-series resistance, the use of “m” real condensers in parallel connected to the load is equivalent to a real condenser with a total capacity C_{ST} and equivalent in-series resistance N times smaller, allowing to increase the efficiency of the energy transfer to the user load.

In particular, with reference to FIG. 16, when a maximum (or minimum) tension V_{Pi} is detected by way of the sensor 18 (not shown in the drawings) on one of the transducers 12, a first step of the conversion occurs by activating, for example by way of the control unit 17, the corresponding signal VCMAXᵢ (or VCMINᵢ), that is, closing the corresponding switch, which entails the connection of the i-th transducer on the inductor L for a time interval with constant duration. Subsequently, in a second step, the corresponding signal VCMAXᵢ (or VCMINᵢ) is de-activated, that is, the corresponding switch is opened and one of the signals VCSTⱼ (1<j<m) is activated, that is, the corresponding switch is closed for a period of time mainly depending on the initial value of the tension VSTⱼ on the j-th outlet storage condenser, on the initial value of the current iL on the inductor L, on the value of capacity CSTⱼ, on the inductance of L and on the value of the serial parasite resistances.

The initial value of the current iL in the second step depends in turn on the initial value in the first step of the tension Vpᵢ on the i-th transducer 12, on the value of the equivalent output capacity Cpᵢ of the i-th transducer and the value of inductance of the inductor L.

And now with reference to FIG. 17 in the first step of the conversion, if by way of the sensor 18 (not shown) a maximum or minimum tension V_{Pi} is detected on the i-th transducer 12, then the control signal SWᵢ is activated together with SW0H, that is, the corresponding switches are closed. The second step of the conversion can take place in two ways: if previously a maximum tension had been detected on the i-th transducer, after de-activating the control signals SWᵢ, SW0H, that is, opening the corresponding switches, the control signals SWⱼ, SW0H are activated, that is the corresponding switches are closed. On the contrary, if previously a minimum tension had been detected on the i-th transducer, after de-activating the control signals SWᵢ, SW0H, that is, opening the corresponding switches, the control signals SWAⱼ, SW0L are activated. The switches SWAⱼ SWBⱼ, according to the tension detected, are activated individually in a mutually exclusive manner, so as to connect a single condenser Cstᵢ at a time to the inductor L.

The duration of the first step of the conversion is constant for each transducer 12. On the contrary the duration of the second step depends on the initial tension value VSTⱼ on the j-th output condenser, on the initial value of the current iL, the value of capacity CSTⱼ, the value of L and the value of the serial parasite resistances. The initial value of the current iL in the second step depends in turn on the initial value in the first step of the tension Vpⱼ on the i-th transducer, on the value of output capacity Cpⱼ of the i-th transducer 12 and on the value of L.

The energy transfer to each output condenser Cstⱼ, that is, the relative load phase, can take place in different ways. For example, in a first solution it is possible to load one condenser at a time passing to the next when the value V_{DD,MAX} has been reached. Or, according to another solution it is possible to increase the tension alternatively on all the output condensers Cstⱼ one at a time. In this way it is possible to guarantee that all the condensers Cstⱼ are maintained approximately at the same tension value. The minimum outlet tension Vdd required by the load will thus be reached in a longer time than in the previous solution, but the load available will be maximum.

When the condensers Cstⱼ are all connected in parallel, there are no energy losses only if they are all at the same tension. In general, if two or more condensers that are at different tensions are connected in parallel, the initial electrostatic energy is not conserved.

Therefore, it will be more advantageous, from the point of view of the energy disposable at output, to load the output condensers Cstⱼ in the second way as described above.

It is clear that modifications and/or additions of parts may be made to the energy conversion and accumulation device 10 as described heretofore, without departing from the field and scope of the present invention. For example, it comes within the field of the present invention to provide that the electric charge 15 is able to activate the electric energy transfer autonomously from the storage element 14. In fact the electric charge 15 can include a feed stage, suitable to effect a translation of tension for the stabilized feed of subsequent user stages of the electric charge 15, which is only activated if the tension value at outlet from the storage element 14, that is, of the condenser Cst, is higher than a predetermined threshold value.

It also comes within the field of the present invention to provide that it is the control unit 17, according to the specific electric requirements of the electric charge 15, that drives a third switch element, not shown in the drawings, and suitable to connect the electric charge 15 and the storage element 14.

It is also clear that, although the present invention has been described with reference to some specific examples, a person of skill in the art shall certainly be able to achieve many other equivalent forms of energy conversion and accumulation device, having the characteristics as set forth in the claims and hence all coming within the field of protection defined thereby.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-30. (canceled)

31. An energy conversion and accumulation device, for the conversion of environmental energy into electric energy, comprising at least one transducer, configured to convert an external environmental stress energy into an electric quantity; at least one storage element, configured to accumulate the electric quantity and/or to transfer the electric quantity to an electric user device; a first switch element, configured to be activated in order to transfer electric energy from the at least one transducer directly to a temporary storage element of electric energy; a second switch element configured to be activated in order to transfer electric energy stored by the temporary storage element directly to the storage element, the device comprising a sensor element, associated both with the at least one transducer and with the temporary storage element, and also with the at least one storage element and configured to detect predetermined energy conditions favorable for the mutually alternate activation of the first switch element and the second switch element for a corresponding alternate electric energy transfer respectively from the at least one transducer to the temporary storage element, with the first switch element closed and the second switch element open, and from the temporary storage element to the at least one storage element, with the first switch element open and the second switch element closed.

32. The device of claim 31, further comprising a control unit, associated with the sensor element and configured to activate the switch elements according to the detection of the sensor.

33. The device of claim 32, wherein the control unit includes a processing unit configured to calculate opening and closing times of the switch elements and corresponding activation instants of said switch elements according to the detections of predetermined energy conditions detected by the sensor element.

34. The device of claim 31, wherein the transducer includes an exit gate configured to be configured as an electric charge capacity, said electric charge being obtained from the environmental energy.

35. The device of claim 31, wherein the transducer is the piezoelectric type.

36. The device of claim 31, wherein the electric energy storage element is a condenser.

37. The device of claim 31, wherein the electric energy temporary storage element is an inductor.

38. The device of claim 37, wherein the inductance value of the inductor is coherent with the transducer and is configured to determine an oscillatory transitory development of the electric quantity during the transfer of the energy from the transducer to the temporary storage element.

39. The device of claim 31, wherein the switch elements include 2 door and/or multi-position switches.

40. The device of claim 31, further comprising a plurality of transducers, operating independently of each other with autonomous mechanical and tension responses, each of the plurality of transducers connected, by ways of individually and alternatively drivable independent switches, to the temporary storage element.

41. The device of claim 31, comprising a plurality of storage elements.

42. The device of claim 31, wherein said storage elements include independently loadable condensers, each having a capacity such as to achieve a parallel equivalent capacity of a predefined value such as to provide to the electric user device the level of tension of working feed for at least a predetermined time period of functioning.

43. An energy conversion and accumulation method for the conversion of environmental energy into electric energy, comprising:
(a) by way of at least one transducer, converting environmental energy entering one entrance of the at least one transducer into an electric quantity exiting from the at least one transducer and configured to be stored in at least one storage element of electric energy and/or transferred to an electric user device, the at least one transducer being selectively connectable by way of a first switch element to a temporary storage element of electric energy, and the temporary storage element of electric energy being selectively connectable to the at least one storage element of electric energy by way of a second switch element;
(b) transferring the electric energy from the at least one transducer to the temporary storage element of electric energy, wherein the first switch element is closed, creating the connection, in correspondence with predetermined energy conditions of the at least one transducer, as detected by way of a sensor element driven by a control unit, keeping the second switch element open; and,
(c) transferring the electric energy from the temporary storage element to the storage element by opening the first switch element and closing the second switch element.

44. The method of claim 43, wherein in step (b) the first switch element is opened after an interval of time calculated according to the energy conditions of the transducer, as detected by the sensor element at the beginning of step (b).

45. The method of claim 43, wherein in step (b) the first switch element is opened at a predetermined time instant corresponding to favorable instantaneous energy conditions of the transducer or of the temporary storage element, as detected by the sensor element.

46. The method of claim 43, wherein in step (c) the second switch element is subsequently opened after a time interval calculated according to the energy conditions of both the temporary storage element and also the storage element, as detected by the sensor element at the beginning of step (c).

47. The method of claim 43, wherein in step (c) the second switch element is subsequently opened at a predetermined time instant corresponding to favorable instantaneous energy conditions of the storage element or of the temporary storage element, as detected by the sensor element.

48. The method of claim 43, wherein the first switch element and the second switch element are activated so as to allow the transfer of the stream of electric energy to the storage element only in a predetermined direction.

49. The method of claim 43, wherein the transducer is the piezoelectric type.

50. The method of claim 43, wherein a plurality of transducers operates independently of each other with autonomous mechanical and tension responses, each one connected, by way of individually and alternatively drivable independent switches (SWi), to said temporary storage element.

51. The method of claim 43, wherein the energy storage is achieved by way of a plurality of storage elements.

52. The method of claim 51, wherein said storage elements include condensers disposed in parallel and loadable independently, each having a capacity such as to achieve an equivalent capacity of a predefined value so as to provide to the electric user device the level of tension of working feed for at least a predetermined time period of functioning.
